(19) United States
(12) Patent Application Publication
(10) Pub. No.: US 2015/0051367 A1
(43) Pub. Date: Feb. 19, 2015

(54) VARIABLE PRESSURE DROP UP FLOW-PRE-POLYMERIZER (UFPP) SYSTEMS AND METHODS

(71) Applicant: Clive Alexander Hamilton, Swainby (GB)

(72) Inventor: Clive Alexander Hamilton, Swainby (GB)

(21) Appl. No.: 14/125,013

(22) PCT Filed: Jun. 4, 2012
(86) PCT No.: PCT/US2012/040745

§ 371 Date: May 20, 2014

Related U.S. Application Data
(60) Provisional application No. 61/495,690, filed on Jun. 10, 2011.

(51) Int. Cl. B01J 19/24; C08G 63/78; C08G 63/181

(52) U.S. Cl. CPC B01J 19/24; C08G 63/181; C08G 63/785
USPC 528/308; 422/644; 422/646

(57) ABSTRACT

Disclosed are processes and systems for manufacturing polyethylene terephthalate (PET) and pre-polymer. The processes and systems use a variable pressure drop up-flow-pre-polymerizer configuration. The pressure profile in the UFPP can be selected to beneficially change the relative reaction rates of the polymerization and esterification reactions. This design maximizes the esterification carried out in the UFPP, while still producing a pre-polymer with the optimum carboxyl end groups concentration (e.g., about 30μ equiv./g to 60μ equiv./g) to maximize finisher productivity. This can result in a reduction of the size and cost of the esterifier required for a given plant throughput.

### BACKGROUND

The manufacturing process for polyethylene terephthalate, used for both polyester fibers and bottle resin, is carried out, totally or in part, in a series of melt phase reactors. In general, the process for polyethylene terephthalate manufacturing can include three melt phase reactors: esterifier, UFPP (Up Flow Pre-Polymerizer), and finisher. All 3 reactors typically operate at temperatures above 270° C., while the operating pressure reduces from super-atmospheric pressure in the first reactor (esterifier) to nearly full vacuum in the final reactor (finisher). The raw materials for the process are ethylene glycol and phthalic acids. The phthalic acids are typically 100% terephthalic acid for polyester fiber but may contain up to 5% isophthalic acid for bottle resins. Catalyst and other additives may be added to the process at any point, but are normally injected after the esterifier.

In the melt phase reactors ethylene glycol is first reacted with terephthalic acid to form an oligomer and water vapor as a by-product and then the oligomer is polymerized to form polymer with ethylene glycol and water as by-products.

There are two main chemical reactions which occur. One of these reactions occurs when a hydroxyl end of one oligomer molecule reacts with the hydroxyl end of another oligomer molecule to form a longer chain oligomer molecule and a molecule of ethylene glycol. After successive reactions the oligomer molecules eventually grow to become polymer molecules. This reaction is called the polymerization reaction. The second of the reactions occurs when a hydroxyl end of an oligomer molecule or an ethylene glycol molecule reacts with the carboxyl end of another oligomer molecule to form a longer chain oligomer molecule and a molecule of water. This reaction is called the esterification reaction. The esterification reaction is favored by higher operating pressures while the polymerization reaction is favored by lower pressures.

Both the esterification and polymerization reactions occur to some extent in all of the melt phase reactors. The esterification reaction dominates the early stages of the melt phase process but later polymerization becomes the dominant reaction mechanism.

Typically about 85-95% of the esterification reaction is complete in the first reactor (esterifier). The size (i.e., residence time) and cost of the esterifier for a given plant throughput is determined by the need to accomplish sufficient esterification at the required esterifier reaction conditions, i.e., temperature and feed molar ratio of ethylene glycol to phthalic acid.

Most of the remaining esterification reaction is completed in the second reactor i.e., the UFPP. The UFPP produces pre-polymer for the finisher from the polyester oligomer made in the esterifier. The finisher completes the polymerization of the pre-polymer product.

Currently, technology and processes for the manufacturing process for polyethylene terephthalate are expensive to build and operate.

### SUMMARY

There is a need in the art to enhance the manufacturing process and equipment for polyethylene terephthalate to reduce operating and capital costs. Briefly described, embodiments of this disclosure include variable pressure drop up-flow-pre-polymerizer systems and methods, and the like that enhance the manufacturing processes and equipment for polyethylene terephthalate.

One exemplary system among others, comprises:
a) a first reaction zone that includes a base tray and a base tray vapor space disposed at the top of the first reaction zone,
b) a second reaction zone that includes a tray and a tray vapor space, wherein the tray includes an upwardly extending hat structure along the center vertical axis of the system, wherein a top tray riser connects the tray with a top tray so that the tray and the top tray are in communication,
c) a third reaction zone that includes the top tray, a bubble cap, and the top tray riser along the vertical center axis of the system that is disposed above the hat structure of the top tray, wherein the second reaction zone is in communication with the third reaction zone through an opening in the top tray riser, and
d) a fourth reaction zone that includes a portion of the top tray outside of the bubble cap and a top tray vapor space, wherein the fourth reaction zone includes a pre-polymer outlet and a vapor outlet, wherein the fourth reaction zone is the area between the tray and the top of the system excluding the area under the bubble cap, wherein the third reaction zone and the fourth reaction zone are in communication through the bubble cap, and where a pressure drop in the system is controlled by one or more of the group consisting of: geometry of the trays and risers, control valve located in the external pipeline riser, flow of the fluid into the base tray, and vapor flow and composition through the vapor outlet.

One exemplary method of forming a pre-polymer, among others, comprises:
a) introducing an oligomer to a first reaction zone, wherein the degree of polymerization of the oligomer introduced is greater than 4,
b) reacting the oligomer in the first reaction zone to produce a by-product vapor comprising ethylene glycol and water,
c) flowing the oligomer and the by-product vapor into a second reaction zone via a control valve restricted riser, wherein the second reaction zone is at a pressure less than that of the pressure in the first reaction zone, wherein the oligomer and the by-product vapor react further in the second reaction zone,
d) flowing the oligomer and the by-product vapor into a third reaction zone via an inner riser, wherein the third reaction zone is at a pressure less than that of the pressure in the second reaction zone, wherein the oligomer and the by-product vapor react further in the third reaction zone,
e) flowing the oligomer and the by-product vapor into a fourth reaction zone via a bubble cap, wherein the fourth reaction zone is at a pressure less than that of the pressure in the third reaction zone, wherein oligomer and the by-product vapor react further to form a pre-polymer,
f) removing the remaining by-product vapor through a vapor outlet, and
g) removing the liquid pre-polymer through a pre-polymer outlet.

One exemplary variable pressure up flow pre-polymerizer (UFPP) system, among others, comprises:
a) a first reaction zone that includes a base tray and a base tray vapor space disposed at the top of the base tray,
b) a second reaction zone that includes a first tray and first tray vapor space, wherein the first tray includes an outer riser disposed around the outside edge of the system, wherein the outer riser is annular on the inwardly facing side, wherein the outer riser wraps around the entire circumference or has two or more openings, wherein the first tray includes an upwardly extending hat structure along the center vertical axis of the system, wherein the first reaction zone in is in communication with the second reaction zone through an opening in the outer riser,
c) a third reaction zone disposed above the second reaction zone that includes a second tray and a second tray vapor space, wherein the tray includes a inner riser along the vertical center axis of the system that is disposed above the hat structure, wherein the second reaction zone is in communication with the third reaction zone through an opening in the inner riser,
d) a fourth reaction zone that includes a third tray and third tray vapor space, wherein the third tray includes a second outer riser disposed around the outside edge of the system, wherein the second outer riser is annular on the inwardly facing side, wherein the second outer riser wraps around the entire circumference or has two or more openings, wherein the third tray includes an upwardly extending hat structure along the center vertical axis of the system, wherein the third reaction zone is in communication with the fourth reaction zone through an opening in the outer riser,
e) a fifth reaction zone that includes a top tray, a bubble cap, and a top tray riser along the vertical center axis of the system that is disposed above the hat structure, wherein the fourth reaction zone is in communication with the fifth reaction zone through an opening in the top tray riser, and
f) a sixth reaction zone that includes a portion of the top tray outside of the bubble cap and a top tray vapor space, wherein a pre-polymer outlet and a vapor outlet are in communication with the sixth reaction zone, wherein the sixth reaction zone is the area between the top tray and the top of the system excluding the area under the bubble cap, wherein the sixth reaction zone is in communication the fifth reaction zone below it through the bubble cap.

One exemplary method of forming a pre-polymer, among others, comprises:
a) introducing an oligomer to a first reaction zone, wherein the degree of polymerization of the oligomer introduced is greater than 4,
b) reacting the oligomer in the first reaction zone to produce a by-product vapors comprising ethylene glycol and water,
c) flowing the oligomer and the by-product vapor into a second reaction zone from the first reaction zone via an outer riser, wherein the second reaction zone is at a pressure less than that of the pressure in the first reaction zone, wherein the oligomer and the by-product vapor react further in the second reaction zone,
d) flowing the oligomer and the by-product vapor into a third reaction zone from the second reaction zone via an inner riser, wherein the third reaction zone is at a pressure less than that of the pressure in the second reaction zone, wherein the oligomer and the by-product vapor react further in the third reaction zone,
e) flowing the oligomer and the by-product vapor into a fourth reaction zone from the third reaction zone via an outer riser, wherein the fourth reaction zone is at a pressure less than that of the pressure in the third reaction zone wherein the oligomer and the by-product vapor react further in the fourth reaction zone,
f) flowing the oligomer and the by-product vapor into a fifth reaction zone from the fourth reaction zone via an top tray riser, wherein the fifth reaction zone is at a pressure less than that of the pressure in the fourth reaction zone wherein the oligomer and the by-product vapor react further in the fifth reaction zone,
g) flowing the oligomer and the by-product vapor into a sixth reaction zone from the fifth reaction zone via a bubble cap, wherein the sixth reaction zone is at a pressure less than that of the pressure in the fifth reaction zone wherein the oligomer and the by-product vapor react further in the sixth reaction zone to form a pre-polymer,
h) removing the by-product vapor through a vapor outlet, and
i) removing the pre-polymer through a pre-polymer outlet.

### BRIEF DESCRIPTION OF THE DRAWINGS

Many aspects of this disclosure can be better understood with reference to the following drawings. The components in the drawings are not necessarily to scale.

FIG. 1 is a sectional view of a single diameter, two tray UFPP system.

FIG. 2 is a sectional view of a single diameter, eight tray UFPP system.

FIG. 3 is a chart showing the impact of pressure of the bottom tray on polymer output for a UFPP pilot system.

FIG. 4 is a chart showing the impact of pressure of the bottom tray on the pressure of the polymeriser for a UFPP pilot system.

FIG. 5 is a chart showing the impact of pressure of the bottom tray on polymer output for a 16 tray UFPP reactor.

FIG. 6 is a chart showing the impact of pressure of the bottom tray on the pressure of the polymeriser for a 16 tray UFPP reactor.

FIG. 7 is a chart showing the impact of pressure of the bottom tray on esterifier operating volume for a 16 tray UFPP reactor.

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

Embodiments of the present disclosure will employ, unless otherwise indicated, techniques of chemistry, chemical engineering, chemical recycling, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in barA.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### DISCUSSION

Embodiments of the present disclosure include variable pressure up flow pre-polymerizer (UFPP) systems, methods, and the like. Embodiments of the systems and methods of the present disclosure can be used to make polyethylene terephthalate. Embodiments of the systems and methods of the present disclosure are advantageous for at least the reason that the pressure profile in the UFPP can be selected to beneficially change the relative reaction rates of the polymerization and esterification reactions; i.e., faster esterification reactions occur at higher pressures in the lower sections of the UFPP, while faster polycondensation reactions occur at the lower pressures in the upper sections of the UFPP. Embodiments of the present disclosure are designed such that the chosen pressure profile maximizes the esterification carried out in the UFPP, while still producing a pre-polymer with the optimum carboxyl end groups concentration (e.g., about 30 equiv./g to 60μ equiv./g) to maximize finisher productivity. This can result in a reduction of the size and cost of the esterifier required for a given plant throughput.

In addition, the oligomer feed stream that is used can vary in the concentration of the carboxyl end groups. The ability to alter the pressure profile allows embodiments of the present disclosure to adjust this altered variable to optimize the properties of the pre-polymer and consequently control the operation of the finisher. The pressure profile can be varied using one or more of the following: the elevations of the trays and/or risers, number and/or geometric arrangements of the trays and risers, number and location of fixed or variable flow restricting devices, and/or adjustment of the variable flow restricting devices. Thus, embodiments of the present disclosure provide a number of ways to adjust the pressure profile to maximize productivity given diverse oligomer feed streams.

Embodiments of the present disclosure can be used for new plants, which may allow smaller reactors upstream and/or downstream from the UFPP system. Also, embodiments of the present disclosure can be used to de-bottleneck existing plants since the pressure profile can be adjusted to maximize production using existing reactors. Furthermore, the shape and size of the UFPP system can be optimized, which may reduce UFPP reactor cost. UFPP reactors can be used at a range of production rates; from development units of about 1 Te/Day to large production units of greater than 2000 Te/Day.

The conventional UFPP reactor includes two cylindrical sections; an upper larger diameter section used for the final stage of pre-polymer reaction and vapor-liquid separation, and a lower smaller diameter section containing a number of trays and risers used for the earlier stages of pre-polymer reaction. Polyester oligomer is fed to the bottom of the UFPP and pre-polymer product and vapor by-products are removed using separate pipelines from the top section of the UFPP. In passing co-currently from the bottom to the top of the UFPP the pressure of the pre-polymer and by-product vapor streams is progressively reduced. This reduction in pressure occurs as a result of both frictional and hydrostatic losses induced by the geometry of the vessel and the arrangement of trays and risers within the vessel. Most UFPPs have 16 trays for holding the reaction inventory with a corresponding number of connecting risers. However, UFPP designs with a different number of trays have also been developed. The upward flowing characteristic of the UFPP is unique among pre-polymerizer designs.

Vodonik (U.S. Pat. No. 2,727,882) teaches that the UFPP was originally developed when the raw materials for the polyethylene terephthalate process were dimethyl terephthalate (DMT) and ethylene glycol. Vodonik teaches that the purpose of using higher pressures during the early stages of pre-polymer reaction is to prevent excessive vaporization of oligomer, which can solidify and plug the UFPP vapor take-off pipeline. The device in Vodonik was based on using DMT as a feedstock and the operating pressure drop was set to prevent low molecular weight oligomers from volatilizing, while maintaining the lowest possible operating pressure to maximize polymerization reaction rates. Since Vodonik used dimethyl terephthalate (DMT) and ethylene glycol, there was no significant esterification required by the process described in Vodonik.

Today, ethylene glycol and phthalic acids (e.g., terephthalic acid) are used to produce polyesters, such as polyethylene terephthalate. It should be noted that terephthalic acid was not commercially available at the time when Vodonik was prepared and filed. Since different chemical species are used today, different chemical reactions occur in embodiments of the present disclosure. The different chemical reactions require different considerations for the configuration of embodiments of the present disclosure as well as different operating conditions. As noted above, since Vodonik used dimethyl terephthalate (DMT) and ethylene glycol, there was no significant esterification required by that process and consequently, Vodonik makes no mention of the importance of using higher pressures to encourage esterification reactions in the UFPP. Embodiments of the present disclosure use a pressure profile in the UFPP to beneficially change the relative reaction rates of the polymerization and esterification reactions. Embodiments of the present disclosure are designed such that the pressure drop maximizes the amount of esterification carried out in the UFPP, while still producing a pre-polymer with the optimum concentration of carboxyl end groups to control the polyester polymer properties and to maximize finisher productivity.

An embodiment of the variable pressure UFPP system can produce a polyester pre-polymer from a polyester oligomer, which is formed from a plurality of reaction chambers or zones (e.g., about 2 to 30 tray and risers) inside a single vessel, where there is a progressive reduction of pressure in successive reactions zones. The reactants and by-products move in an upward direction through successive reaction zones as the operating pressure is progressively reduced according to a pressure profile that has been selected to optimize the balance of polymerization and esterification reactions to maximize the productivity of the esterification and/or finisher reactors. As the liquids are swept upward through the UFPP by the relatively more rapid ascent of vapors, a pressure drop is affected from reaction zone to reaction zone until a final lower pressure prevails at the top of the vessel. In an embodiment, the pressure drop of the system can be varied independently of the liquid flow by a variable flow restricting devices so that the same system can be operated at different pressure drops under different conditions (e.g., varying oligomer feed streams). In particular, the pressure drop can be automatically controlled using variable flow restricting devices (e.g., control valve), to achieve a desired carboxyl end group (CEG) end group concentration such as about 30 to 55 microeq./gm. The CEG can be measured in the prepolymer leaving the UFPP using an NIR type measurement, or other means. In another embodiment, the pressure drop is achieved by the arrangement (e.g., alternating center to inside edge placement of risers) of fixed flow restricting devices (e.g., which can vary in diameter and height) inside the UFPP. In another embodiment, variable flow restricting devices and an arrangement of fixed flow restricting devices can be used to control the pressure drop.

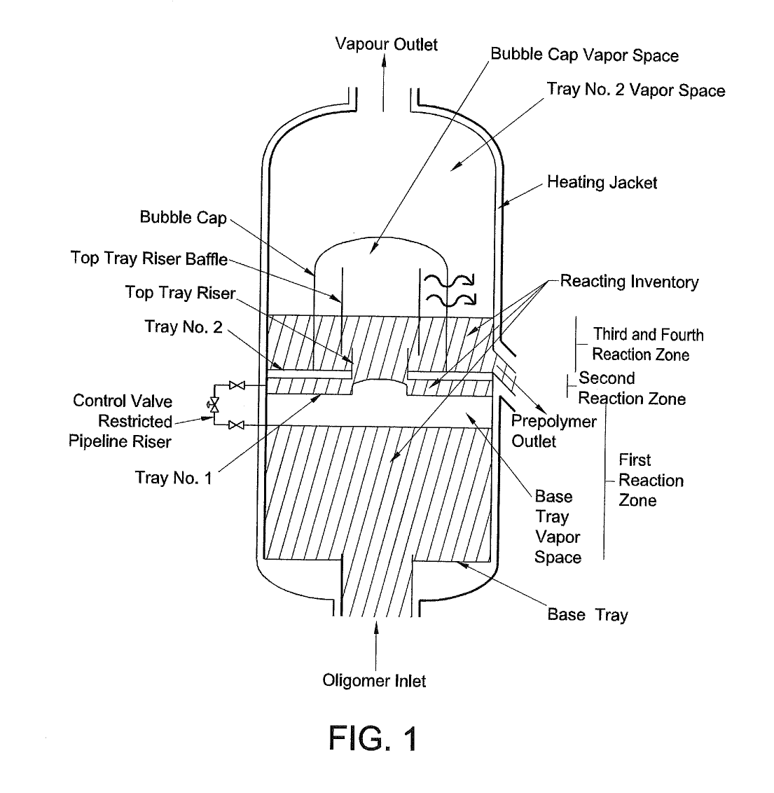

FIG. 1 illustrates an embodiment of a variable pressure UFPP system. The system will be described in general and then in more detail below. FIG. 1 shows a single diameter, two tray UFPP where the pressure drop is controlled by use of a control valve located in an external pipeline riser. The pipeline riser is generally configured for both vapor and oligomer flows and to avoid accumulation or “no-flow” zones. The system in FIG. 1 includes a heating jacket that can be used to control the temperature (e.g., about 275° to about 305° C., where the temperature in the base tray and the top tray are within about ±5° C.) in the system. In general, the system can be considered a vessel having one or more reaction zones. As shown in FIG. 1, the system includes four reactions zones. Each reaction zone includes a liquid mixture (e.g., an oligomer mixture that is converted into a pre-polymer mixture as it rises to the top of the vessel) and a vapor space disposed above the liquid. Each reaction zone includes a bottom, sides, and top, where there may be one or more risers, pipelines, inlets, or outlets to communicate liquid and vapor (e.g., reaction by-product vapor) from one reaction zone to another reaction zone. The pressure in each reaction zone can be controlled, which allows for the control of the reaction in the liquid.

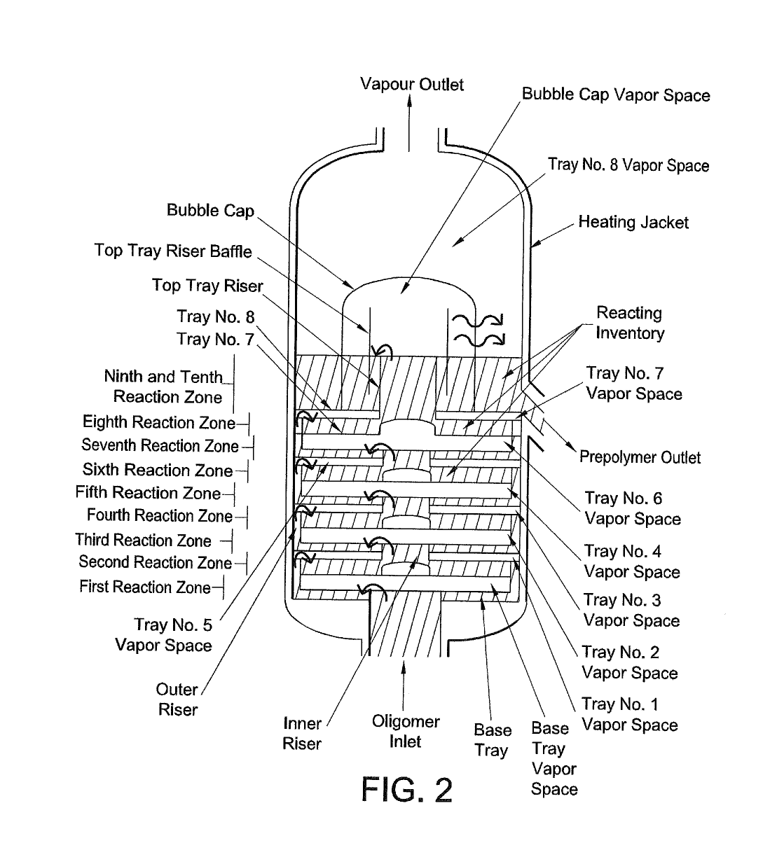

The first reaction zone includes a base tray that includes the initial oligomer mixture (e.g. oligomer, catalysts, additives, etc) and a base tray vapor space disposed above the oligomer. The tray spacing between the top surface of adjacent trays is typically about 0.1 meters (m) to about 10 m, and these dimensions are applicable to other embodiments described herein (e.g., FIG. 2). Lower vessel diameters are dependent on the production rate, but are typically about 1 m to about 7 m, and these dimensions are applicable to other embodiments described herein (e.g., FIG. 2). Upper vessel diameters can be the same as the lower vessel diameter or larger and are typically about 1 m to about 10 m, and these dimensions are applicable to other embodiments described herein (e.g., FIG. 2). The aspect ratio (ratio of cylindrical height to diameter) of the UFPP is typically about 2 to about 20, and these dimensions are applicable to other embodiments described herein (e.g., FIG. 2). Development scale reactors are usually smaller than the dimensions given here. An external pipeline riser connects the base tray with tray no. 1. The external pipeline riser can be connected to the side of the first reaction zone above the bottom of the base tray. The external pipeline riser can be connected to the side of the second reaction zone above the bottom of tray no. 1.

The second reaction zone includes tray no. 1 that includes the liquid and tray no. 1 vapor space. Tray no. 1 can include an upwardly extending “hat” structure along the center vertical axis of the system. The second reaction zone is sized to control the extent of reaction for the preferred operating conditions. The vapor space on each tray can occupy about 5 to about 95% of the tray spacing; with the same or different vapor space heights for each tray. The hat structure functions to control the liquid depth on alternate trays and the size of the flow gap between trays to achieve the required pressure profile in the UFPP. Additional details regarding the hat structure are described below.

The third reaction zone includes tray no. 2 (in this embodiment the top tray), a bubble cap, and a riser along the vertical center axis of the system that is disposed above the hat structure. Liquid and vapor can flow through the orifice of the riser. The riser can have an area for flow of about 1 to about 95% of the vessel cross-sectional area. The dimensions of the height and diameter can affect a pressure drop and are adjusted to control the properties of the prepolymer flowing to the finisher. The bubble cap is disposed over a portion of tray no. 2. The third reaction zone is the area between tray no. 2 and the bubble cap. The bubble cap is configured to effectively separate prepolymer and vapor; avoid liquid droplet carryover to the vapor system, as known by those skilled in the art. The width or the diameter of the hat structure and the central riser are about the same. The height of the edge of the hat structure is lower than the level of tray no. 2 and slopes up to the height of the middle of the hat structure. The bubble cap includes an inertial separation mechanism that allows the liquid and vapor to pass through portions of the wall of the bubble cap.

The fourth reaction zone includes the liquid disposed on a portion of tray no. 2 outside of the bubble cap and tray no. 2 vapor space. A pre-polymer outlet and a vapor outlet are in communication with the fourth reaction zone so each can be removed from the system. The fourth reaction zone is the area between tray no. 2 and the top of the system excluding the area under the bubble cap. In an embodiment, the third and fourth reaction zones are considered a single zone.

Having described the components of the system, the flow of the liquid and vapor are described below. The oligomer can be introduced to the base tray via one or more oligomer inlets. The degree of polymerization of the oligomer introduced is greater than 4 or greater than 4.5. The oligomer starts to react and produces by-product vapors comprising ethylene glycol and water. The liquid and vapor can be communicated from the base tray to tray no. 1 via a control valve restricted riser that is disposed on the outside of the system. The flow of the liquid and vapor can be varied by the control valve restricted riser, which can alter the pressure and the corresponding reaction.

The liquid and vapor can be introduced to tray no. 2 via a centrally disposed tray no. 2 riser. In an embodiment, a liquid seal is formed between the hat structure and the riser while maintaining a tray no. 1 vapor space.

The liquid and vapor can be communicated through the bubble cap to an area of tray no. 2 outside of the bubble cap. The vapor can flow through the vapor outlet and is processed further. After a sufficient time, the liquid, at this stage a pre-polymer, can be removed from the system via the pre-polymer outlet.

The pressure in each of the reaction zones can be controlled by the control valve restricted riser; the flow of the oligomer through the oligomer inlet; the design of each tray, each hat structure, the riser, the riser baffles, the bubble cap; and/or the vapor flow and composition through the vapor outlet.

As briefly described above, the liquid at a controlled temperature (e.g., about 275° C. to about 305° C.) containing a metal catalyst salt (e.g., antimony, tin, zinc, magnesium, titanium or others known to those skilled in the art) and additives (e.g., color modifiers or toners, such as cobalt salts, dyes or pigments and polymer modifiers, such as oligomers, cross-linking agents, ionic salts such as organic sulfonates and chain terminators) are fed into the system through the oligomer inlet and onto the base tray. On the base tray the oligomer starts to react, producing vapor by-products as it flows upward to the external pipeline riser, which connects the base tray to tray no. 1. The pressure in the first reaction zone is controlled by the vapor pressure above tray no. 2 and the differential pressure down the UFPP to achieve the required balance of esterification and polymerization reactions. Restricting the flow of oligomer and vapor by-products passing through the external pipeline riser using a control valve. The pressure in the first reaction zone is about 100 mBara to about 960 mBara, including 125 mBara to 350 mBara at a temperature of about 275° C. to 305° C. The liquid and vapor that has passed through the control valve and flows on to tray no. 1 is at a lower pressure than it was on the base tray, and consequently the balance of esterification and polymerization reactions has changed, i.e., the esterification reaction rate is reduced and the polymerization reaction rate is increased. The liquid continues to react as it flows across tray no. 1 producing more vapor by-product and is conducted to tray no. 2 (the top tray) by an internal riser. The geometry of the entrance to the riser and the height of the riser give rise to further pressure drop, so that the top tray operates at a lower pressure than tray no. 1, of about 10 mBara to about 100 mBara, including about 20 mBara to 50 mBara. This again results in a further change in the balance of esterification and polymerization reactions. The liquid on the top tray is retained for sufficient time to achieve the desired degree of polymerization before allowing the liquid (pre-polymer) to flow to the finisher via the pre-polymer outlet. The liquid/pre-polymer residence time on the top tray is controlled, at least in part, by regulating the prepolymer level on the tray and the oligomer feed to the UFPP. The pressure on the top tray of the UFPP is maintained using a vacuum system, such as an ejector, which draws away the by-product vapor produced. The pre-polymer and vapor by-products are separated on the top tray using a “bubble cap”, which employs an inertial separation mechanism for separating vapor from liquid. In an embodiment, the bubble cap is fitted with a riser baffle to improve its efficiency at separating vapor from liquid.

The relative size of the present apparatus and its components, i.e., cross-sectional area of the vessel, height, width or diameter, of the trays, can be dependent upon the quantity of materials fed to the vessel, the viscosity of pre-polymer desired for maximum rate of feed, the hold-up time required and the pressure profile inside the UFPP vessel.

FIG. 1 could be designed to include additional trays that include control valve restricted pipeline risers and/or risers, for the communication of the liquid and vapor up through the system.

As noted above, the pressure profile can be varied using one or more of the following: the elevations of the trays and/or risers, geometric arrangements of the trays and risers, location of fixed or variable flow restricting devices, and/or adjustment of the variable flow restricting devices.

FIG. 2 illustrates another embodiment of the present disclosure. In this embodiment, the pressure drop can be controlled by a series of fixed flow restricting devices or risers. FIG. 2 illustrates a single diameter, eight tray UFPP system. In this design liquid and vapor flows upward through the system passing from tray to tray via alternate inner and outer risers. The pressure in the system is progressively reduced from tray to tray as a result of fixed flow restrictions at the inlet to each riser, liquid pool depth on each tray and the elevation differences between successive trays. The flow restrictions, liquid pool depth and the tray elevations are designed to give the desired pressure drop. The pressure for each tray can be optimized as needed using standard optimization techniques.

The system shown in FIG. 2 will be described in general and then in more detail below. The system includes a heating jacket that can be used to control the temperature (e.g., 275° to 305° C., where the temperature in the base tray and the top tray are within about ±5° C.) in the system. The system includes ten reactions zones. Each reaction zone includes a liquid mixture (e.g., an oligomer mixture that is converted into a pre-polymer mixture as it rises to the top of the vessel) and a vapor space disposed above the liquid. Each reaction zone includes a bottom, sides, and top, where there may be one or more risers, inlets, or outlets to communicate liquid and vapor (e.g., reaction by-product vapor) from one reaction zone to another reaction zone. The pressure in each reaction zone can be controlled, which allows for the control of the reaction in the liquid.

The first reaction zone includes a base tray that includes the initial oligomer mixture (e.g. oligomer, catalysts, additives, etc) and a base tray vapor space disposed above the oligomer. The tray spacing between the top surface of adjacent trays is about 0.1 m to about 10 m. Lower vessel diameters are dependent on the production rate, but are typically about 1 m to about 7 m. Upper vessel diameters can be the same or similar as the lower vessel diameter or larger and up to about 10 m. The aspect ratio (ratio of cylindrical height to diameter) of the UFPP is typically about 2 m to about 20 m. Development scale reactors are usually smaller than the dimensions given here. The second reaction zone includes tray no. 1 that includes the liquid and tray no. 1 vapor space. Tray no. 1 can include a riser disposed around the outside edge of the system. The riser is annular on the inwardly facing side. The riser can wrap around the entire circumference or can have two or more openings. The width of the riser (or orifice) can include an upwardly extending “hat” structure along the center vertical axis of the system. The hat structure functions to retain the required depth of the liquid pool on Tray 1 and set the flow gap to Tray 2, thereby helping to set the pressure drop between adjacent trays. Additional details regarding the hat structure are described below.

The third reaction zone includes tray no. 2 that includes the liquid and tray no. 2 vapor space. Tray no. 2 can include a riser along the vertical center axis of the system that is disposed above the hat structure of tray no. 1. The riser can have an area for flow of about 1 to about 95% of the vessel cross-sectional area or can have a combination of a height and width to affect a pressure from the pressure in the second reaction zone. The bottom portion of the riser in tray no. 2 does not go below the top portion of the riser of tray no. 1 because such overlap can cause instability in the operation of the system. Thus, the top portion and bottom portion of risers for each of the trays in the system do not overlap the bottom portion or the top portion of the risers of trays above or below. The width or the diameter of the hat structure and the riser are about the same. The height of the middle of the hat structure is about at the level of tray no. 2, but in the open area of the riser. The height of the edge of the hat structure is lower (e.g., about 10 to 90%) than the level of tray no. 2 and slopes up to the height of the middle of the hat structure.

The fourth, sixth, and eighth reaction zones are similar to reaction zone two. However, the pressure in fourth reaction zone is lower than the pressure in second reaction zone, the pressure in sixth reaction zone is lower than that in fourth reaction zone, and the pressure in eighth reaction zone is lower than the pressure in the sixth reaction zone.

The fifth and seventh reaction zones are similar to third reaction zone. However, the pressure in fifth reaction zone is lower than the pressure in third reaction zone and the pressure in seventh reaction zone is lower than that in fifth reaction zone.

The ninth reaction zone includes tray no. 8, a bubble cap, and a riser along the vertical center axis of the system that is disposed above the hat structure. The bubble cap is disposed over a portion of tray no. 8. The ninth reaction zone is the area between tray no. 8 and the bubble cap. The bubble cap includes an inertial separation mechanism similar to that described above in reference to FIG. 1 that allows the liquid and vapor to base through portions of the wall of the bubble cap.

The tenth reaction zone includes the liquid disposed on a portion of tray no. 8 outside of the bubble cap and tray no. 8 vapor space. A pre-polymer outlet and a vapor outlet are in communication with the tenth reaction zone so each can be removed from the system. The tenth reaction zone is the area between tray no. 8 and the top of the system excluding the area under the bubble cap. In an embodiment, the ninth and tenth reaction zones are considered a single zone.

The tray spacing between the top surface of adjacent trays is typically about 0.1 m to about 10 m. Having described the components of the system, the flow of the liquid and vapor are described below. The oligomer can be introduced to the base tray via one or more oligomer inlets. The degree of polymerization of the oligomer introduced is greater than 4 or greater than 4.5. The oligomer starts to react and produces by-product vapors. The liquid and vapor can be communicated from the base tray to tray no. 1 via the riser of tray no. 1.

The liquid and vapor can be introduced to tray no. 2 via a centrally disposed tray no. 2 riser. In an embodiment, a liquid seal is formed between the hat structure and the riser while maintaining a vapor space on tray no. 1.

The liquid and vapor can be communicated through tray nos. 3 to 8 as the liquid and vapor are communicated from base tray, tray no. 1, and tray no. 3.

The liquid and vapor can be communicated through the bubble cap to an area of tray no. 8 outside of the bubble cap. The vapor can flow through the vapor outlet and is processed further. After a sufficient time, the liquid, at this stage a pre-polymer, can be removed from the system via the pre-polymer outlet.

The pressure in each of the reaction zones can be controlled by the flow of the oligomer through the oligomer inlet; the design of each tray, each hat structure, the inside and outer risers, the riser baffles, the bubble cap; and/or the vapor flow through the vapor outlet.

The intrinsic viscosity for the formed pre-polymer in embodiments of the present disclosure is about 0.2 to 0.4 dl/g or about 0.31 to 0.4 dl/g. The pressure profile can be varied using one or more of the following: the elevations of the trays and/or risers, and the number and/or geometric arrangements of the trays and risers.

### EXAMPLES

Now having described the embodiments of the present disclosure, in general, the following Examples describe some additional embodiments of the present disclosure. While embodiments of present disclosure are described in connection with the following examples and the corresponding text and figures, there is no intent to limit embodiments of the present disclosure to this description. On the contrary, the intent is to cover all alternatives, modifications, and equivalents included within the spirit and scope of embodiments of the present disclosure.

Embodiments of the present disclosure have been demonstrated by modeling examples of commercial scale UFPP reactors, modeling different pressure drops (dP) on the UFPP reactors, and simulations of 8-tray and 2-tray UFPP reactors.

The models used have been used successfully for the development, design, operation and modification of UFPP and other types of PET polymerisation reactors.

Embodiments of the present disclosure have also been demonstrated on a 1 metric tonne per day continuous pilot plant comprising four reactors. The first reactor or primary esterifier (PE) can be fed with a terephthalic acid (TA)/ethylene glycol (EG) paste, with a mole ratio in the range from 1.01:1 to 1.6:1. The PE operates at supra-atmospheric pressures with a reactor residence time about two hours and at a temperature in the range of about 255° C. to about 270° C. The paste typically contains the polymerisation catalyst. The second reactor or secondary esterifier (SE) has a residence time of about one hour and typically operates at atmospheric pressure and at a temperature of about 260° C. to about 280° C. For the purposes of these examples the SE pressure has been varied to simulate the UFPP pressure drop (dP). Toner, typically a cobalt salt is injected before the secondary esterifier. The third reactor or low polymeriser (LP) is operated at about 50 mBara, has a residence time of about 40 minutes and operates at a temperature of about 270° C. to about 285° C. The final reactor or high polymeriser (HP) operates under vacuum control whereby the reactor pressure is adjusted to control the measured viscosity of the final product. In the following examples the HP pressure is set to 4 mBara. The final reactor residence time is about one hour at a temperature of about 270° C. to about 285° C.

The primary esterifier can be a forced recirculating vessel with a rectification column overhead. Ethylene glycol (EG) vapor and water (H2O) vapor flows to the rectification column and EG is separated and returned to the primary esterifier vessel as a liquid. Water-rich vapor flows from the top of the column and is condensed, thereby driving the esterification reaction to around 90% completion. The remaining reactors are typically horizontal wiped-wall vessels from which the EG and H₂O vapors are condensed and can be either recirculated to prepare the TA/EG paste or collected for disposal.

The polymer from the final reactor has been collected and measured using standard PET analytical measurements, typically intrinsic viscosity (iV), carboxyl end group analysis (COOH), diethylene glycol analysis (DEG) and X-ray fluorescence (XRF) analysis for metals. A constant throughput is used for all the examples, 50 kg/hr.

### Example 1

Typical operating conditions for the 4 vessel polyester pilot plant are given in Table 1. The SE represents the bottom tray of an UFPP reactor and the low polymeriser (LP) represents the top tray. The plant process conditions are maintained constant, operating the LP at 50 mBara pressure. To simulate changes to the pressure drop (dP) across the UFPP the SE pressure is varied.

TABLE 1
Pilot Plant operating conditions and product analyses

| Parameter | units | Example 1 | Example 2 | Example 3 | Example 4 |
|---|---|---|---|---|---|
| TA:EG | mole ratio | 1.11:1 | 1.11:1 | 1.11:1 | 1.11:1 |
| PE Temp | ° C. | 265 | 265 | 265 | 265 |
| PE Pressure | Barg | 3.5 | 3.5 | 3.5 | 3.5 |
| SE Temp | ° C. | 280 | 280 | 280 | 280 |
| SE Pressure | mBara | 960 | 500 | 200 | 350 |
| HP Temp | ° C. | 280 | 280 | 280 | 280 |
| HP Pressure | mBara | 4.0 | 4.6 | 0.6 | 5.1 |
| HP iV | dl/g | 0.612 | 0.610 | 0.521 | 0.612 |
| HP COOH | microeq/g | 28.2 | 31.4 | 107.5 | 41.1 |
| Sb | ppm | 280 | 280 | 280 | 280 |
| P | ppm | 6.5 | 6.5 | 6.5 | 6.5 |
| Co | ppm | 25 | 25 | 25 | 25 |
| L | CIE | 67.9 | 67.1 | 69.6 | 68.8 |
| B | CIE | −0.2 | −0.3 | −2.3 | −1.1 |

Parameters that were considered are the impact of SE pressure on HP COOH, HP pressure and product color.

### Example 2

The SE pressure has been reduced.

The small increase in COOH from 28.2 to 31.4 has resulted in the increase in HP pressure from 4.0 mBara to 4.6 mBara. This effect indicates a more reactive oligomeric feed composition to the HP.

### Example 3

The SE pressure is reduced too far, resulting in a very high COOH product. This material fails to reach the iV target (˜0.61 iV), even at the 0.6 mBara (minimum) pressure setpoint of the HP reactor.

Colors L and B have improved as a consequence of the higher HP COOH and the lower iV achieved.

### Example 4

The SE pressure at 350 mBara has resulted in the optimum product for the same fixed recipe, i.e., it has the best color and the highest HP pressure.

We can consider graphically the data generated in examples 1-4 as follows:

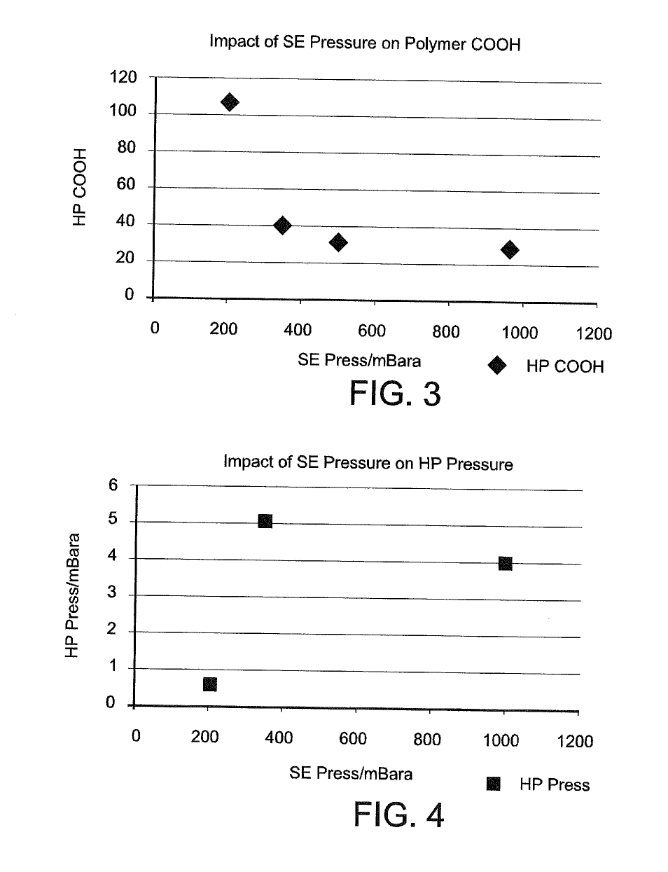

FIG. 3 shows that as the SE pressure is reduced (or the dP defined as the LP pressure minus the SE pressure is reduced) we see the HP COOH rising.

Similarly, FIG. 4 shows that as the HP pressure improving (increasing) as the SE pressure is reduced from 960 mBara to 350 mBara and then decreasing rapidly at 200 mBara.

### Example 5

An example for a 16-tray UFPP reactor deployed in an embodiment of the invention, operating at a throughput of 1200 tonnes per day.

TABLE 2
UFPP conditions and product analyses

| Parameter | units | Example 5 | Example 7 | Example 8 |
|---|---|---|---|---|
| UFPP inlet COOH | microequiv/g | 609 | 573 | 576 |
| UFPP | No. of trays | 16 | 8 | 2 |
| UFPP Temp | ° C. | 292 | 292 | 292 |
| UFPP Pressure | mbara | 26.7 | 26.7 | 26.7 |
| UFPP dP | mbar | 170 | 150 | 241 |
| UFPP residence | mins | 40 | 54 | 60 |
| time | | | | |
| UFPP COOH | microequiv/g | 53 | 38 | 45 |
| Finisher Pressure | mbara | 2.87 | 2.75 | 2.27 |
| Finisher iV | dl/g | 0.622 | 0.622 | 0.622 |
| Finisher COOH | microeq/g | 40.3 | 35.6 | 40.3 |

Parameters of interest include the Finisher COOH and the Finisher pressure.

### Example 6

Predicted impact of UFPP pressure drop—keeping all of the parameters in Example 5 constant and varying the pressure drop results in the following simulation results for a 16 tray UFPP:

TABLE 3
Effect of 16-tray UFPP pressure drop on product properties

| UFPP | Finisher COOH/ | Finisher |
|---|---|---|
| dP/mbar | microeq · gm | P/mbara |
| 169 | 40.3 | 2.9 |
| 235 | 32.7 | 2.7 |
| 300 | 28.1 | 2.5 |
| 370 | 25.4 | 2.3 |
| 500 | 22.7 | 2.1 |

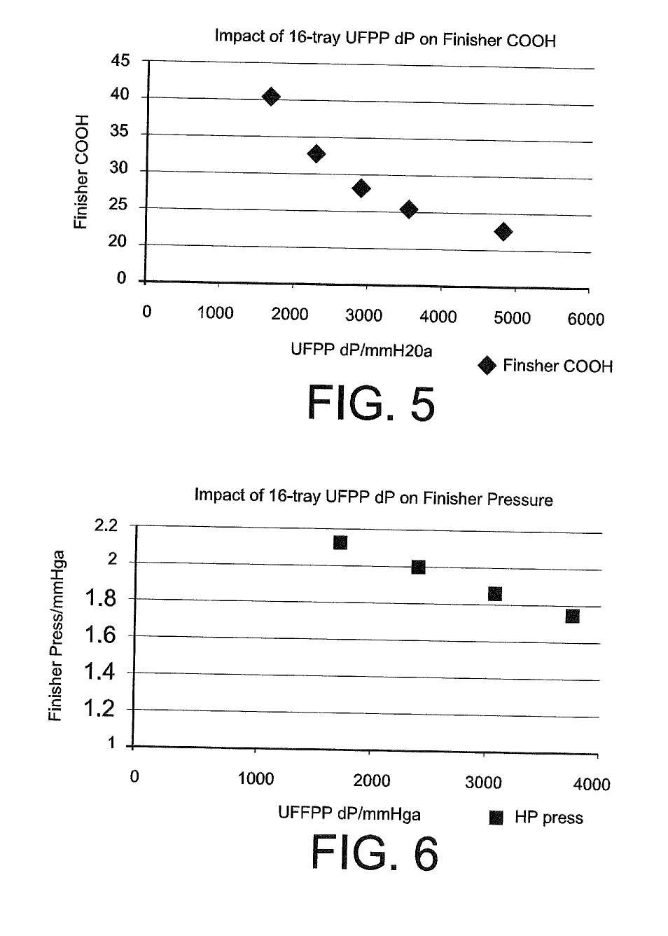

Table 3 is represented graphically in FIGS. 5 and 6. FIGS. 5 and 6 show that an increase in polymer COOH with decreasing UFPP dP and below an increasing finisher pressure with decreasing UFPP dP.

An advantage of this phenomenon is that for the same UFPP volume or reactor sizing, the esterifier operating volume can be reduced for the same process conditions, as highlighted in the table below:

TABLE 4
Impact of 16-tray UFPP conditions on Esterifier sizing

| | | Estimated |
|---|---|---|
| UFPP T3 | Finisher COOH/ | Esterifier |
| dP/mbar | microeq · gm | volume/m3 |
| 170 | 40.3 | 175 |
| 235 | 39.7 | 135 |
| 300 | 40.5 | 105 |
| 370 | 41.3 | 86 |
| 500 | 40.1 | 77 |

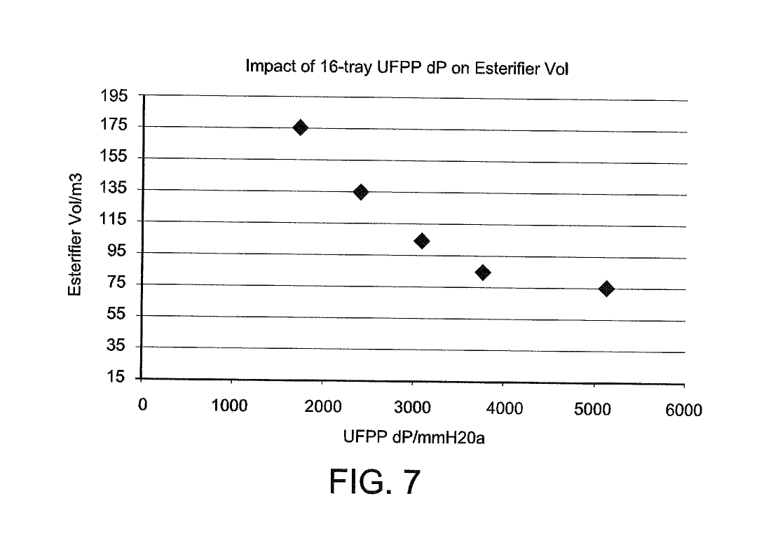

Table 4 is represented graphically in FIG. 7. FIG. 7 shoes that the estimated esterifier volume falls with increasing UFPP dP, for a given production plant capacity.

### Example 7

An estimate of the operation of an 8-tray UFPP embodiment, using the same esterifier and finisher vessels and conditions as before is given in Table 2.

The impact of pressure drop is given in Table 5:

TABLE 5
Effect of 8-tray UFPP pressure drop on product properties

| UFPP T3 | Finisher COOH/ | Finisher |
|---|---|---|
| dP/bar | microeq · gm | P/mbara |
| 150 | 35.6 | 2.69 |
| 130 | 38.9 | 2.77 |
| 109 | 43.1 | 2.84 |
| 88 | 48.4 | 2.85 |
| 67 | 55.4 | 2.75 |

As the 8-tray UFPP dP is reduced the finisher COOHs increase and the finisher pressure first rises and then falls, as with the 16-tray embodiment.

### Example 8

An estimate of the operation of a 2-tray UFPP embodiment using the same esterifier and finisher vessels and conditions as before is given in Table 2.

The impact of pressure drop is given in Table 6:

TABLE 6
Effect of 2-tray UFPP pressure drop on product properties

| UFPP | Finisher COOH/ | Finisher |
|---|---|---|
| dP/mbar | microeq · gm | P/mbara |
| 241 | 31.8 | 2.27 |
| 174 | 32.9 | 2.31 |
| 107 | 34.8 | 2.38 |
| 40 | 38.4 | 2.49 |

As the 2-tray UFPP dP is reduced the finisher COOHs increase and the finisher pressure rises, as with the 16-tray embodiment.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also the individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

Many variations and modifications may be made to the above-described embodiments. All such modifications and variations are intended to be included herein within the scope of this disclosure and protected by the following claims.

What is claimed is:

1. A variable pressure up flow pre-polymerizer (UFPP) system, comprising:
a) a first reaction zone that includes a base tray and a base tray vapor space disposed at the top of the first reaction zone,
b) a second reaction zone that includes a tray and a tray vapor space, wherein the tray includes an upwardly extending hat structure along the center vertical axis of the system, wherein a top tray riser connects the tray with a top tray so that the tray and the top tray are in communication,
c) a third reaction zone that includes the top tray, a bubble cap, and the top tray riser along the vertical center axis of the system that is disposed above the hat structure of the top tray, wherein the second reaction zone is in communication with the third reaction zone through an opening in the top tray riser, and
d) a fourth reaction zone that includes a portion of the top tray outside of the bubble cap and a top tray vapor space, wherein the fourth reaction zone includes a pre-polymer outlet and a vapor outlet, wherein the fourth reaction zone is the area between the top tray and the top of the system excluding the area under the bubble cap, wherein the third reaction zone and the fourth reaction zone are in communication through the bubble cap, and where a pressure drop in the system is controlled by one or more selected from the group consisting of the geometry of the trays and risers, a control valve located in the external pipeline riser, a flow of the fluid into the base tray, and a vapor flow and composition through the vapor outlet.

2. The system of claim 1, further comprising a heating jacket that controls the temperature in each of the reaction zones.

3. The system of claim 1, wherein each reaction zone includes a liquid mixture and a vapor space disposed above the liquid.

4. The system of claim 1, having an aspect ratio (ratio of cylindrical height to diameter) of about 2 to about 20.

5. The system of claim 1, wherefrom reacting material can flow, via a pipeline riser fitted with a pressure or flow control device, from the first reaction zone to the second reaction zone.

6. The system of claim 1, wherein the tray in the second reaction zone is in communication with the top tray in the third reaction zone via a number of additional trays and risers, wherein the additional trays and risers create additional reaction zones, and wherein the number of additional trays is between 2 and 20.

7. A method of forming a pre-polymer, comprising,
a) introducing an oligomer to a first reaction zone, wherein the degree of polymerization of the oligomer introduced is greater than 4,
b) reacting the oligomer in the first reaction zone to produce a by-product vapor comprising ethylene glycol and water,
c) flowing the oligomer and the by-product vapor into a second reaction zone via a control valve restricted riser, wherein the second reaction zone is at a pressure less than that of the pressure in the first reaction zone, wherein the oligomer and the by-product vapors react further in the second reaction zone,
d) flowing the oligomer and the by-product vapor into a third reaction zone via an inner riser, wherein the third reaction zone is at a pressure less than that of the pressure in the second reaction zone, wherein the oligomer and the by-product vapors react further in the third reaction zone,
e) flowing the oligomer and the by-product vapor into a fourth reaction zone via a bubble cap, wherein the fourth reaction zone is at a pressure less than that of the pressure in the third reaction zone, wherein the oligomer and the by-product vapors react further to form a pre-polymer,
f) removing the remaining by-product vapor through a vapor outlet, and
g) removing the pre-polymer through a pre-polymer outlet.

8. The method of claim 7, wherein the pressure is controlled by one or more of the members selected from the group consisting of geometry of the trays and risers, control valve located in the external pipeline riser, flow of the fluid into the base tray, and vapor flow and composition through the vapor outlet.

9. The method of claim 7, wherein the oligomer is comprised of ethylene glycol and phthalic acid components

10. A variable pressure up flow pre-polymerizer (UFPP) system, comprising:
a) a first reaction zone that includes a base tray and a base tray vapor space disposed at the top of the base tray,
b) a second reaction zone that includes a first tray and a first tray vapor space, wherein the first tray includes an outer riser disposed around the outside edge of the system, wherein the outer riser is annular on the inwardly facing side, wherein the outer riser wraps around the entire circumference or has two or more openings, wherein the first tray includes an upwardly extending hat structure along the center vertical axis of the system, wherein the first reaction zone is in communication with the second reaction zone through an opening in the outer riser,
c) a third reaction zone disposed above the second reaction zone that includes a second tray and a second tray vapor space, wherein the second tray includes a inner riser along the vertical center axis of the system that is disposed above the hat structure, wherein the second reaction zone is in communication with the third reaction zone through an opening in the inner riser,
d) a fourth reaction zone that includes a third tray and a third tray vapor space, wherein the third tray includes a second outer riser disposed around the outside edge of the system, wherein the second outer riser is annular on the inwardly facing side, wherein the second outer riser wraps around the entire circumference or has two or more openings, wherein the third tray includes an upwardly extending hat structure along the center vertical axis of the system, wherein the third reaction zone is in communication with the fourth reaction zone through an opening in the second outer riser,
e) a fifth reaction zone that includes a top tray, a bubble cap, and a top tray riser along the vertical center axis of the system that is disposed above the hat structure, wherein the fourth reaction zone is in communication with the reaction zone through an opening in the top tray riser, and
f) a sixth reaction zone that includes a portion of the top tray outside of the bubble cap and a top tray vapor space, wherein a pre-polymer outlet and a vapor outlet are in communication with the sixth reaction zone, wherein the sixth reaction zone is the area between the top tray and the top of the system excluding the area under the bubble cap, wherein the sixth reaction zone is in communication the fifth reaction zone below it through the bubble cap.

11. The system of claim 10, further comprising
g) a seventh reaction zone disposed above the fifth reaction zone in that includes a fourth tray and a fourth tray vapor space, wherein the fourth tray includes a second inner riser along the vertical center axis of the system that is disposed above the hat structure, wherein the fifth reaction zone in is in communication with the seventh reaction zone in through an opening in the second inner riser,
h) an eighth reaction zone that includes a fifth tray and fifth tray vapor space, wherein the fifth tray includes an third outer riser disposed around the outside edge of the system, wherein the third outer riser is annular on the inwardly facing side, wherein the third outer riser wraps around the entire circumference or has two or more openings, wherein the fifth tray includes an upwardly extending hat structure along the center vertical axis of the system, wherein the seventh reaction zone in is in communication with the eighth reaction zone in through an opening in the third outer riser,

12. The system of claim 10, wherein the tray spacing between a top surface of adjacent trays is about 0.1 m to about 10 m.

13. The system of claim 10, wherein the number of trays and risers in the UFFP may be between 2 and 20.

14. A method of forming a pre-polymer, comprising,
a) introducing an oligomer to a first reaction zone, wherein the degree of polymerization of the oligomer introduced is greater than 4,
b) reacting the oligomer in the first reaction zone to produce a by-product vapor comprising ethylene glycol and water,
c) flowing the oligomer and the by-product vapor into a second reaction zone from the first reaction zone via an outer riser, wherein the second reaction zone is at a pressure less than that of the pressure in the first reaction zone, wherein the oligomer and the by-product vapor react further in the second reaction zone,
d) flowing the oligomer and the by-product vapor into a third reaction zone from the second reaction zone via an inner riser, wherein the third reaction zone is at a pressure less than that of the pressure in the second reaction zone, wherein the oligomer and the by-product vapors react further in the third reaction zone,
e) flowing the oligomer and the by-product vapor into a fourth reaction zone from the third reaction zone via an outer riser, wherein the fourth reaction zone is at a pressure less than that of the pressure in the third reaction zone, wherein the oligomer and the by-product vapors react further in the fourth reaction zone,
f) flowing the oligomer and the by-product vapor into a fifth reaction zone from the fourth reaction zone via an top tray riser, wherein the fifth reaction zone is at a pressure less than that of the pressure in the fourth reaction zone, wherein the oligomer and the by-product vapors react further in the fifth reaction zone,
g) flowing the oligomer and the by-product vapor into a sixth reaction zone from the fifth reaction zone via a bubble cap, wherein the sixth reaction zone is at a pressure less than that of the pressure in the fifth reaction zone, wherein oligomer and the by-product vapors react further in the sixth reaction zone to form a pre-polymer,
h) removing the remaining by-product vapor through a vapor outlet, and
i) removing the pre-polymer through a pre-polymer outlet.
